(19) United States
(12) Patent Application Publication
(10) Pub. No.: US 2022/0318741 A1
(43) Pub. Date: Oct. 6, 2022

(54) Apparatus and Method For Tracking Food Items With Images

(71) Applicant: Remarkable Foods, Inc., Clark, NJ (US)

(72) Inventor: Yi Wang, Scarsdale, NY (US)

(21) Appl. No.: 17/219,876

(22) Filed: Mar. 31, 2021

(51) Int. Cl. G06Q 10/08; G06K 19/06; G06Q 30/02

(52) U.S. Cl. CPC G06Q 10/0833; G06K 19/06028; G06K 19/06037; G06Q 30/0282

(57) ABSTRACT

An apparatus and method for tracking food items with images improves upon existing approaches to customer service. A food preparation and delivery system includes a control center computing system that receives a completion notification from a vehicle. The completion notification indicates that preparation of a food item has been completed and has an associated image of the food item. The image includes a code attached to the food item and the code includes a tracking identifier. The control center computing system links the tracking code to the food item. Subsequently, a customer can provide a review of the food item and include an image of the food that includes the code. The code within the image from the customer can be decoded to obtain the tracking identifier and for accurately linking the review and the image from the customer with a record of the food item.

### TECHNICAL FIELD

Embodiments of the technology relate generally to preparation and delivery of food items and using images and quick response codes to track the food items.

### BACKGROUND

The popularity of food take-out and food delivery services continues to grow. One aspect of customer service related to food take-out and food delivery services is the ability for the customer to provide a review regarding the customer's experience. The review can include feedback regarding the food purchased, feedback regarding the service the customer received, and feedback regarding the customer's overall experience.

When dining in a restaurant, the customer has the opportunity to provide feedback to the wait staff or the chef as the customer is consuming the food. In contrast, with food take-out and food delivery services, the customer consumes the food in a different location from the restaurant, such as a residence, an office, outdoors, or some other location. Accordingly, the customer's ability to provide feedback regarding the food or the service is limited.

One approach to providing feedback in the take-out and delivery scenarios is for the customer to complete an electronic review using a personal computing device and submitting the review to the service provider. The consumer can provide ratings and comments regarding the food, the service, and the overall experience, but this feedback is limited because it takes place remotely from the restaurant. Accordingly, improved techniques that allow customers to provide more detailed feedback regarding food take-out and food-delivery would be beneficial.

### SUMMARY

The present disclosure is generally directed to a food preparation and delivery system wherein the system enables tracking of food items using images of the food items. In one example embodiment, the present disclosure is directed to a method wherein a control computing system can transmit an order comprising a menu item to a mobile kitchen vehicle, wherein the mobile kitchen vehicle can be operable to prepare the menu item. In response to preparation of the menu item, the control computing system can receive from the mobile kitchen vehicle, a completion notification indicating preparation of the menu item is complete, the completion notification having an associated image of the menu item in its completed state. An image processing system associated with the control computing system can decode a code within the associated image of the menu item to obtain a tracking identifier associated with the menu item. In response to obtaining the tracking identifier, the control computing system can link the tracking identifier with a menu item identifier, the menu item identifier being associated with the menu item.

In the foregoing example, the code within the associated image is attached to a container containing the menu item. The code can be, for example, a quick response code or a bar code. In the foregoing example, the mobile kitchen vehicle can comprise a camera system that captures the associated image of the menu item and an onboard computing system, wherein the onboard computing system transmits the completion notification having the associated image of the menu item to the control computing system upon receiving an input that preparation of the menu item is complete.

In the foregoing example method, the control computing system can receive a customer review, the customer review having an associated customer image of the menu item. The image processing system can decode a customer code within the associated customer image of the menu item to obtain a customer tracking identifier associated with the menu item and the control computing system can link the customer review, the associated customer image of the menu item, and the customer tracking identifier with the menu item identifier. The example method can further comprise the control computing system receiving a refund request for the menu item; retrieving the tracking identifier, the customer review, the associated customer image of the menu item, and the customer tracking identifier; determining, by the control computing system, that the tracking identifier and the customer tracking identifier match; and issuing a refund. Additionally, the example method can further comprise the control computing system retrieving the customer review based on a threshold score within the customer review; determining, by the image processing system, a score for the associated customer image of the menu item, the score based on one or more of a color quality and lighting quality of the associated customer image of the menu item; and publishing, by the control computer system, the menu item and the associated customer image.

In another example embodiment, the present disclosure is directed to a system for preparing and delivering food items. The system can comprise a control computing system, wherein the control computing system is operable to receive an order comprising a menu item and a mobile kitchen vehicle operable to prepare the menu item. The control computing system comprises computer-readable instructions executable by a processor, the computer-readable instructions comprising transmitting, by the control computing system, the order comprising the menu item to the mobile kitchen vehicle; and receiving, at the control computing system from the mobile kitchen vehicle, a completion notification indicating preparation of the menu item is complete, the completion notification having an associated image of the menu item in its completed state. An image processing system associated with the control computing system can decode a code within the associated image of the menu item to obtain a tracking identifier associated with the menu item; and the control computing system can link the tracking identifier with a menu item identifier, the menu item identifier associated with the menu item.

In the foregoing example system, the code within the associated image is attached to a container containing the menu item. The code can be, for example, a quick response code or a bar code. In the foregoing example, the mobile kitchen vehicle can comprise a camera system that captures the associated image of the menu item and an onboard computing system, wherein the onboard computing system transmits the completion notification having the associated image of the menu item to the control computing system upon receiving an input that preparation of the menu item is complete.

In the foregoing example system, the control computing system can receive a customer review, the customer review having an associated customer image of the menu item. The image processing system can decode a customer code within the associated customer image of the menu item to obtain a customer tracking identifier associated with the menu item and the control computing system can link the customer review, the associated customer image of the menu item, and the customer tracking identifier with the menu item identifier. The example system can further comprise the control computing system receiving a refund request for the menu item; retrieving the tracking identifier, the customer review, the associated customer image of the menu item, and the customer tracking identifier; determining, by the control computing system, that the tracking identifier and the customer tracking identifier match; and issuing a refund. Additionally, the example system can further comprise the control computing system retrieving the customer review based on a threshold score within the customer review; determining, by the image processing system, a score for the associated customer image of the menu item, the score based on one or more of a color quality and lighting quality of the associated customer image of the menu item; and publishing, by the control computer system, the menu item and the associated customer image.

In yet another example embodiment, the present disclosure is directed to a non-transitory computer-readable medium comprising computer-executable instructions. The instructions can comprise transmitting, by a control computing system, an order comprising a menu item to a mobile kitchen vehicle, wherein the mobile kitchen vehicle can be operable to prepare the menu item. In response to preparation of the menu item, the instructions can further comprise the control computing system receiving from the mobile kitchen vehicle, a completion notification indicating preparation of the menu item is complete, the completion notification having an associated image of the menu item in its completed state. An image processing system associated with the control computing system can decode a code within the associated image of the menu item to obtain a tracking identifier associated with the menu item. The computer-executable instructions can further comprise, in response to obtaining the tracking identifier, the control computing system linking the tracking identifier with a menu item identifier, the menu item identifier associated with the menu item.

In the foregoing example embodiment, the code within the associated image is attached to a container containing the menu item. The code can be, for example, a quick response code or a bar code. In the foregoing example, the mobile kitchen vehicle can comprise a camera system that captures the associated image of the menu item and an onboard computing system, wherein the onboard computing system transmits the completion notification having the associated image of the menu item to the control computing system upon receiving an input that preparation of the menu item is complete.

In the foregoing example, the computer-readable instructions can further comprise receiving, by the control computing system, a customer review, the customer review having an associated customer image of the menu item. The image processing system can decode a customer code within the associated customer image of the menu item to obtain a customer tracking identifier associated with the menu item and the control computing system can link the customer review, the associated customer image of the menu item, and the customer tracking identifier with the menu item identifier. The example computer-readable instructions can further comprise the control computing system receiving a refund request for the menu item; retrieving the tracking identifier, the customer review, the associated customer image of the menu item, and the customer tracking identifier; determining, by the control computing system, that the tracking identifier and the customer tracking identifier match; and issuing a refund. Additionally, the example computer-readable instructions can further comprise the control computing system retrieving the customer review based on a threshold score within the customer review; determining, by the image processing system, a score for the associated customer image of the menu item, the score based on one or more of a color quality and lighting quality of the associated customer image of the menu item; and publishing, by the control computer system, the menu item and the associated customer image.

The foregoing embodiments are non-limiting examples and other aspects and embodiments will be described herein. The foregoing summary is provided to introduce various concepts in a simplified form that are further described below in the detailed description. This summary is not intended to identify required or essential features of the claimed subject matter nor is the summary intended to limit the scope of the claimed subject matter.

### BRIEF DESCRIPTION OF THE DRAWINGS

The accompanying drawings illustrate only example embodiments of an apparatus and method for tracking food items with images and therefore are not to be considered limiting of the scope of this disclosure. The principles illustrated in the example embodiments of the drawings can be applied to alternate methods and apparatus. Additionally, the elements and features shown in the drawings are not necessarily to scale, emphasis instead being placed upon clearly illustrating the principles of the example embodiments. Certain dimensions or positions may be exaggerated to help visually convey such principles. In the drawings, the same reference numerals used in different embodiments designate like or corresponding, but not necessarily identical, elements.

FIG. 1 is a block diagram illustrating a system for tracking food items with images in accordance with the example embodiments of the disclosure.

FIG. 2 is another block diagram illustrating a vehicle that is part of the system of FIG. 1 in accordance with the example embodiments of the disclosure.

FIG. 3 is a flow chart of an example method for tracking food items with images in accordance with the example embodiments of the disclosure.

FIG. 4A is a flow chart of an example method for providing a review with an image in accordance with the example embodiments of the disclosure.

FIG. 4B is a flow chart of an example method for providing a review with an image in accordance with the example embodiments of the disclosure.

FIG. 5 is a flow chart of an example method requesting a refund in accordance with the example embodiments of the disclosure.

FIG. 6 is flow chart of an example method of using a submitted image in accordance with the example embodiments of the disclosure.

### DETAILED DESCRIPTION OF EXAMPLE EMBODIMENTS

The example embodiments discussed herein are directed to apparatus and methods for tracking food items using images. The example embodiments described herein can provide an improved approach for customers to provide reviews of food items received via take-out or delivery services. It should be understood that food delivery services include but are not limited to food prepared at a restaurant, at a ghost kitchen, or prepared in a vehicle during the delivery of the food.

Specifically, the example embodiments described herein provide a system for a user to provide a review that includes the ability to submit one or more customer-captured images of the food item that was purchased and delivered. A tracking code embedded in the one or more images of the food item allows a service provider to accurately link the image to an electronic record of the food item. Accurately linking the image of the food item to the record of the food item allows the service provider to ensure the image corresponds to the record of the food item. Additionally, receiving an image of the food item with the review enables the service provider to better assess the quality of the food and service that was provided. Receiving more detailed and accurate customer reviews with images enables the service provider to more readily identify problems and to improve the level of service it provides.

In the following paragraphs, particular embodiments will be described in further detail by way of example with reference to the drawings. In the description, well-known components, methods, and/or processing techniques are omitted or briefly described. Furthermore, reference to various feature(s) of the embodiments is not to suggest that all embodiments must include the referenced feature(s).

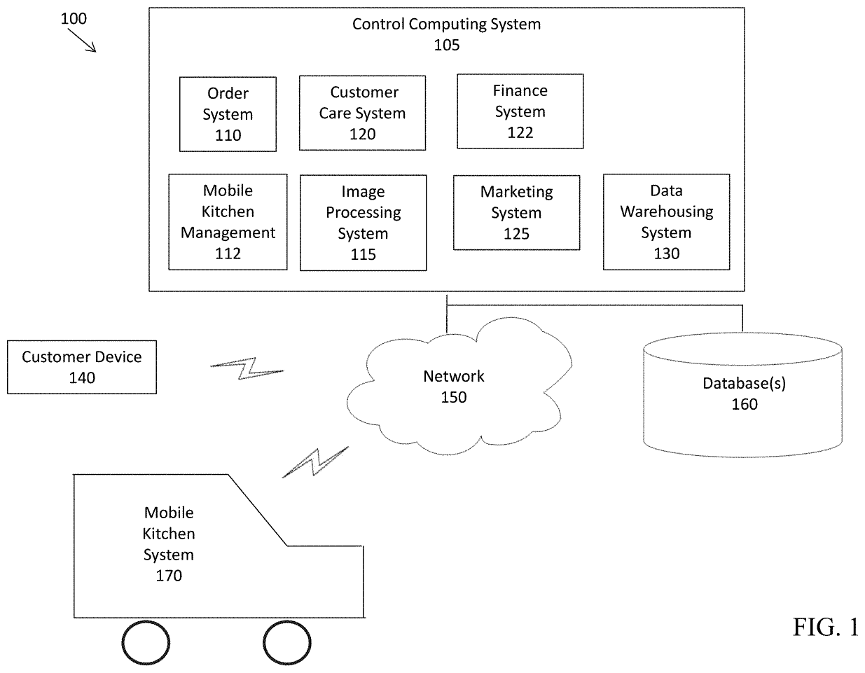

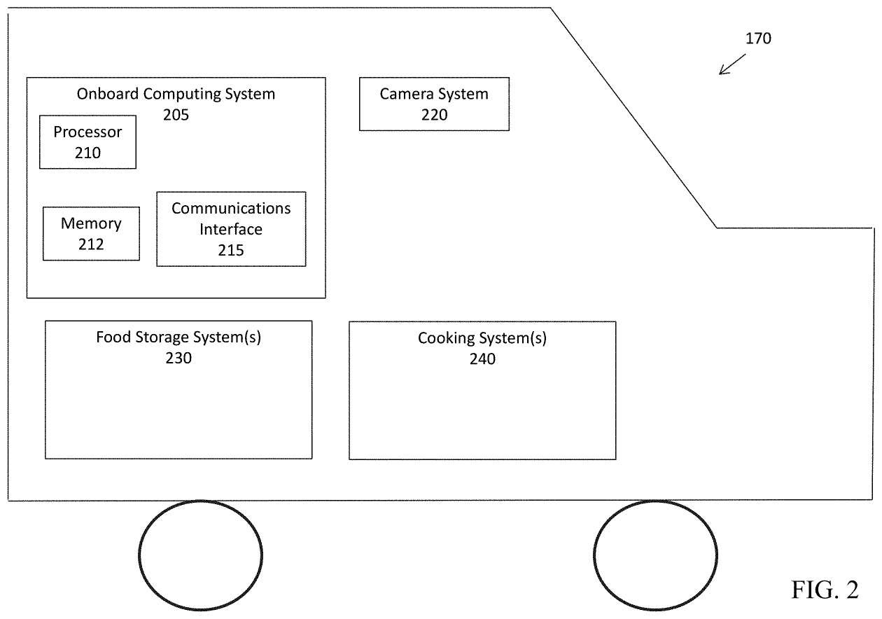

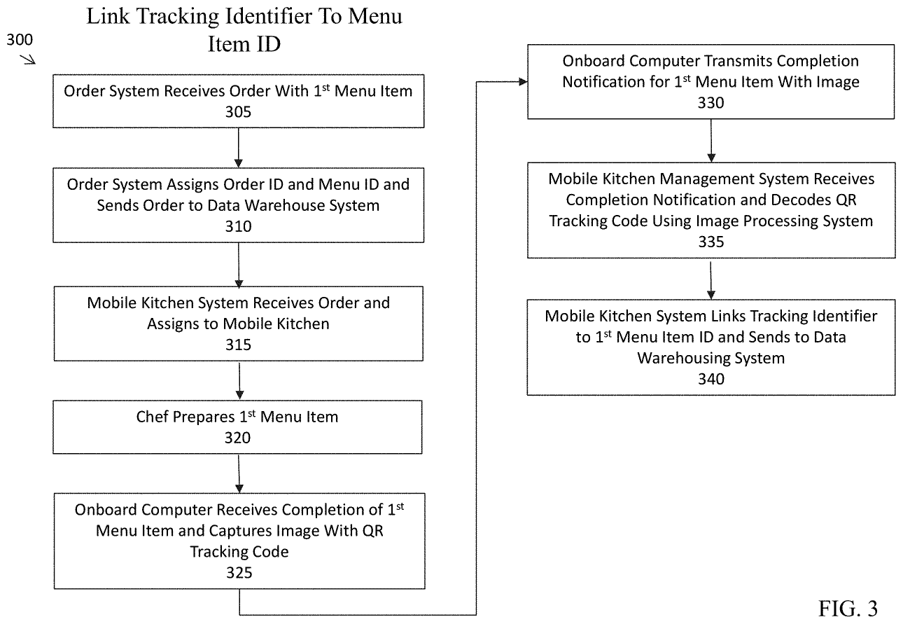

FIG. 1 illustrates the overall system that enables tracking of food items using images. FIG. 2 provides an illustration of a mobile kitchen vehicle used in connection with the system of FIG. 1. FIGS. 3-6 illustrate example methods of tracking food items using images and the advantages those methods provide.

Referring now to FIG. 1, a block diagram is provided illustrating the architecture of an example food preparation and delivery system 100. The system 100 comprises a control computing system 105 and a mobile kitchen system 170. While only one mobile kitchen system 170 is illustrated in FIG. 1 for simplicity, it should be understood that the system is scalable and is designed to support multiple mobile kitchen systems. The one or more mobile kitchen systems communicate with the control computing system via a network 150 that can include one or more of a cellular mobile network, a wide area network, and the Internet. Additionally, customers can communicate orders for food items via network 150, or an alternate communications network, to the control computing system 105. The customers can communicate orders using a customer device 140, such as a mobile telephone, a smart phone, or a personal computer. While only one customer device 140 is illustrated in FIG. 1 for simplicity, it should be understood that the system is designed to support a large number of orders from a multitude of customer devices.

The example control computing system 105 comprises a several subsystems illustrated in FIG. 1. The subsystems can be implemented as software, hardware, or a combination of software and hardware. Additionally, the subsystems can be implemented as software applications executing on the control computing system or they can be implemented as software applications or services implemented on separate or remote computing systems. While the subsystems illustrated in FIG. 1 are shown as discrete subsystems of the control computing system 105, it should also be understood that in some examples the subsystems can be combined with each other or with other subsystems not illustrated in the example of FIG. 1.

The subsystems of control computing system 105 include an order system 110 that receives orders for food items from customer devices. The order system 110 hands off customer orders to the mobile kitchen management system 112, which manages the assignment of orders to and communications with mobile kitchen systems. The subsystems further include an image processing system 115 that comprises software for analyzing images. As will be described further below, the image processing system 115 can analyze images from the mobile kitchen systems and from customer devices to identify tracking codes attached to food items in the images. The image processing system 115 can also evaluate images to assess their quality for use in marketing.

Additional example subsystems of control computing system 105 include a customer care system 120, a finance system 122, a marketing system 125, and a data warehousing system 130. The customer care system 120 can communicate with customer devices regarding reviews of food preparation and food delivery services and can address quality or service concerns. The finance system 122 can process transactions with customer devices including requests for refunds. The marketing system 125 can evaluate images of food items received from customer devices and determine whether the image can be used for promotional purposes. Lastly, the data warehousing system can manage the exchange of data with the various subsystems and the storing of data in one or more databases 160.

FIG. 2 illustrates a more detailed view of mobile kitchen system 170. The mobile kitchen system 170 comprises a vehicle with subsystems including food storage systems 230, cooking systems 240, and an onboard computing system 205. The onboard computing system 205 can include a processor 210, memory 212, a communications interface 215, and a camera system 220. The onboard computing system 205 can receive orders for food items from the mobile kitchen management system 112 via a communications network. The orders for food items can be for one or more customers and each order can include instructions for preparing the food items using the cooking systems 240, such as an oven and a rethermalizer. The onboard computing system 205 can display the instructions for preparing the food items to a chef onboard the vehicle. The food storage systems 230 can contain the ingredients and previously prepared food items that are used in fulfilling the customer orders.

The camera system 220 can comprise one or more cameras located within the vehicle that can be used to track the progress and the quality of the food preparation. The cameras can supply images of a food item to the onboard computing system 205 and the images can be associated with the food item that is currently being prepared. When the preparation of a food item is completed, the chef can provide an input to the onboard computing system 205 indicating that the food item is completed. The camera system 220 can capture one or more images of the completed food item in its packaging.

The packaging can include a code, such as a bar code or a quick response code, that is visible on the packaging and that is captured in the images taken by the camera system 205. In one example, the code can be located on a label with an adhesive backing that is applied to the packaging of the food item. In this way, labels can be pre-printed with codes so that they can be efficiently applied to packaging for food items. Alternatively, the codes can be created and printed on labels in the vehicle as a food item is being completed. When the code is created and printed on the label in the vehicle, the code can comprise or be derived from the order identifier and the menu item identifier. In order to ensure the code is visible in the images of the food item, the label can be applied to a surface of the packaging that is readily visible. In one example, the packaging can include a rim that extends horizontally along the edges of the packaging and the label can be placed on the horizontally extending rim. In other embodiments, the code can be applied to other readily visible portions of the packaging.

Once the camera system captures an image of the completed food item with the code, the onboard computing system 205 can transmit a completion notification with an associated image to the mobile kitchen management system 112 of the control computing system 105. The image processing system 115 can identify the code in the image and read a tracking identifier embedded in the code. Alternatively, the image processing system can use the code to obtain a tracking identifier in a look-up table. Once the tracking identifier is isolated, the mobile kitchen management system 112 can link the tracking identifier to a menu item identifier for the food item that was completed and the data can be sent to the data warehousing system 130 for storage in database 160.

The functions of the control computing system 105 and the onboard computing system 205 can be implemented with software and hardware. Both the control computing system 105 and the onboard computing system 205 can comprise one or more hardware processors, non-transitory computer-readable memory (which can include volatile and persistent memory), and a communication interface. The non-transitory computer-readable memory can store software, algorithms, instructions and data that can be executed by the one or more processors. For example, instructions for processing an image of a food item to identify a tracking code can be stored in memory for execution by the processor. The instructions executed by the processor can also include commands sent via the communication interface from the control computing system 105 to the onboard computing system 205. Examples of the instructions executed by the processor of the control computing system 105 are described in further detail in connection with the example methods of FIGS. 3-6.

The processor(s) of the control computing system 105 and onboard computing system 205 can be implemented in a variety forms that are generally known, including but not limited to a central processing unit, a multi-core processor, a system on a chip, a field programmable gate array, and an application-specific integrated circuit. The memory can include both volatile and persistent memory and can store computer-readable instructions for execution by the processor(s) as well as data such as images of food items and customer reviews. In certain example embodiments, in addition to or as an alternative to local memory, computer-readable instructions and data can be stored remotely in database 160 or on a cloud-based server. The communications interface of the control computing system 105 and the onboard computing system 205 can support long range wireless communication, for example via a cellular network.

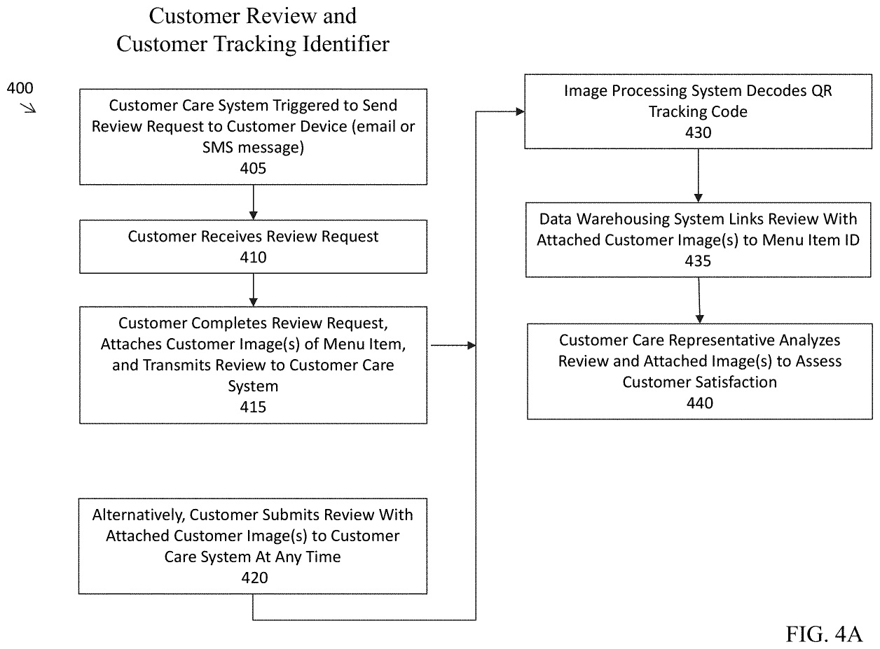

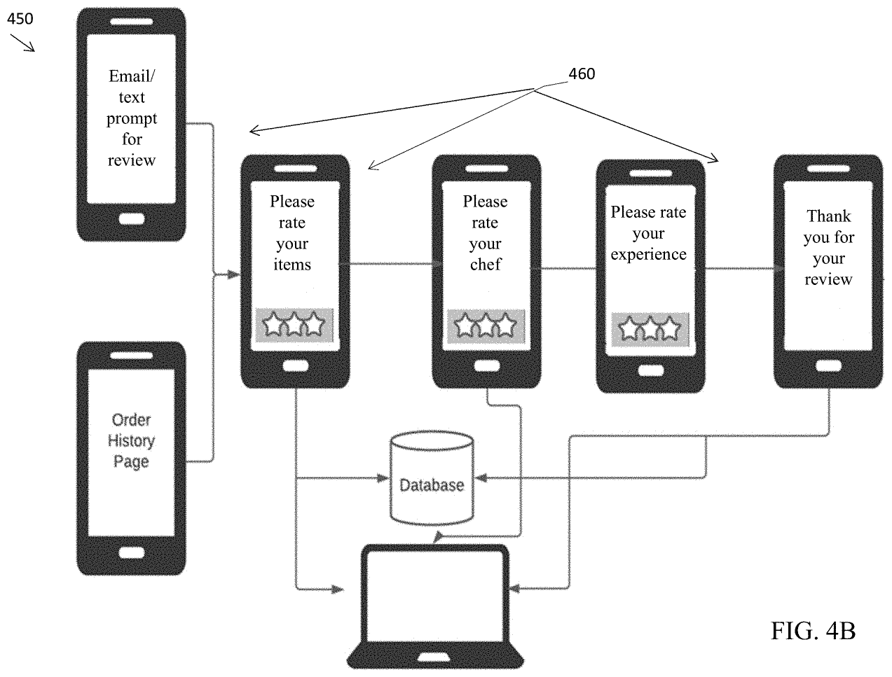

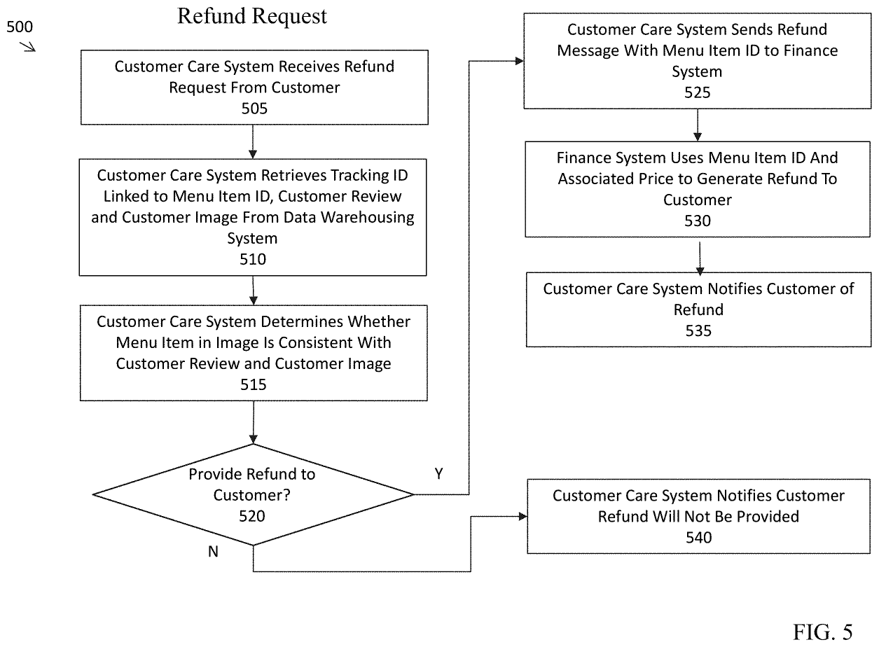

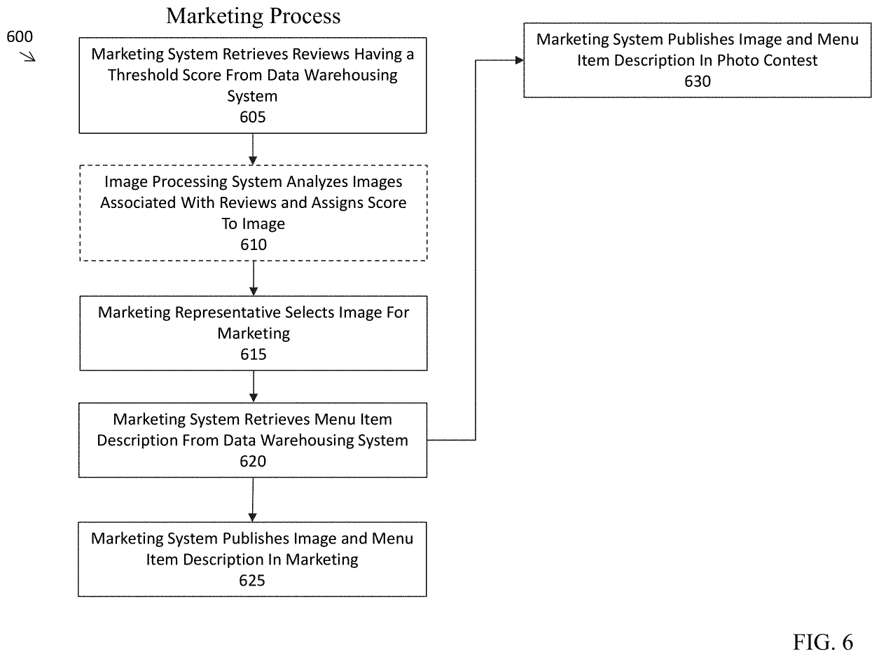

Referring now to FIGS. 3-6, example methods for operation of the food preparation and delivery system 100 are illustrated. The example methods illustrated in FIGS. 3-6 can include algorithms stored as computer-readable instructions in memory for execution by the various systems of the control computing system 105 and the onboard computing system 205. FIG. 3 illustrates an example method 300 for linking a QR tracking code contained in an image to a menu item. FIGS. 4A and 4B illustrate an example method 400 for linking a review and an associated image of a food item to a menu item. FIG. 5 illustrates an example method 500 for processing a customer's refund request using the previously described image of the menu item. FIG. 6 illustrates an example method 600 for a marketing process using the previously described image of the menu item.

Referring to FIG. 3, example method 300 begins with step 305 wherein computer executable instructions executed in connection with the order system 110 receive an order with one or more menu items from a customer. In step 310, the order system 110 can assign a menu item identifier to each menu item in the customer order and, optionally, an order identifier to the order for purposes of tracking the menu item and the order. The order system optionally can provide the order identifier and the menu item identifier to the data warehouse system for storing the information in database 160 for later use. In step 315, the mobile kitchen management system 112 can receive the order comprising the menu item and the associated identifiers and can transmit the order to the mobile kitchen system 170.

The onboard computing system 205 can receive the order with the identifiers and can provide the associated preparation instructions to the chef for preparing the menu item. In step 320, the chef prepares the menu item and provides an input to the onboard computing system 205 that the menu item is completed. When the menu item is completed, a tracking code can be applied to the packaging of the completed menu item. In step 325, the camera system 220 captures one or more images of the completed menu item, wherein the image(s) include the tracking code.

In step 330, the onboard computing system 205 transmits a completion notification to the mobile kitchen management system 112. The completion notification indicates the preparation of the menu item is complete and the notification has an associated image of the menu item in its completed state. In step 335, the mobile kitchen management system 112 receives the completion notification and decodes the code in the image of the menu item. The mobile kitchen management system can use the image processing system 115 associated with the control computing system 105 to decode the code within the associated image of the menu item to obtain a tracking identifier associated with the menu item. In response to obtaining the tracking identifier, the mobile kitchen management system 112 can link the tracking identifier with the menu item identifier. Once the tracking identifier is linked to the menu item identifier, it can be useful in a variety of processes as described in connection with FIGS. 4A-6.

Referring to FIG. 4A, an example method 400 is illustrated for receiving a review from a customer for the menu item. A designated time after the completed menu item is delivered from the mobile kitchen vehicle to the customer, the customer care system 120 can be triggered to send a review request to the customer's device 140 in step 405. The review request can be in the form of an email, a text message, or a notification in an application running on the customer's device 140. As examples, the designated time can be 30 minutes, 60 minutes, or 120 minutes after delivery of the menu item to the customer. In step 410, the customer device 140 receives the review request. In step 415, the customer completes the review request. In connection with completing the review request, the customer can be prompted to use the customer device 140 to capture one or more images of the menu item for sending with the review back to the customer care system 120.

In FIG. 4B, an example process flow 450 is provided showing the screens displayed on the customer device 140 giving the customer the opportunity to provide feedback. The customer may initiate the review by navigating to an order history page. Alternatively, the customer can be prompted by an email, a text message, or a notification in an application to provide a review. The review can give the customer an opportunity to provide feedback about the quality of the food items, the quality of the chef's service, and the overall experience. The customer can provide feedback in the review in the form of text-based input or by selecting a numeric rating such as a number of stars. The customer can capture one or more images of the menu item using the device's camera and the customer can choose to add an image or images of the menu item to the review at any point along the process flow 450 as the customer is providing feedback. For example, as indicated by the arrows 460, the customer can add one or more images of the menu item to the review at the beginning of the review process, as the customer is preparing the review, or at the end of the review process.

As an alternative to steps 405-415 of FIG. 4A, the customer can also choose to provide feedback and images about a menu item at any time as indicated by step 420. In other words, the customer is not required to wait to receive a review request from the customer care system 120 before providing feedback. For example, if the customer recognizes a problem upon receiving the menu item, such as the food delivered does not match the food that was ordered, the customer can immediately submit feedback with an image of the menu item. As another example, if the customer is pleased with the appearance of the menu item upon receipt, the customer may want to submit feedback and images of the menu item before eating the menu item.

In step 430, after receiving a review from the customer, the customer care system 120 can use the image processing system 115 to decode a customer code within the associated customer image of the menu item. In other words, because the tracking code is placed in a visible location on the menu item packaging, when the customer takes an image of the menu item, the tracking code will be visible in the image and can be decoded using the image processing system 115. The image processing system 115 can be used to obtain a customer tracking identifier associated with the menu item from the customer's image of the menu item. In step 435, the data warehousing system 130 can link the customer review and associated customer image with a matching record for the menu item that was previously stored in the database 160.

In one example, if the menu item identifier was included with the customer review, the menu item identifier can be used to locate the matching record for the menu item and the customer tracking identifier can be used as a verification comparison against the tracking identifier that was previously identified and stored in connection with example process 300. However, if the menu item identifier was not included in the customer review, the data warehousing system 130 can use the customer tracking identifier in a look-up process to locate a matching tracking identifier that was previously stored in order to identify the correct menu identifier. The look-up process is particularly useful in situations where the customer has multiple menu items and it may be unclear from the review which of the multiple items is being reviewed. In such situations, the data warehousing system 130 uses the customer tracking identifier associated with the customer image of the menu item to accurately look up the menu item identifier that has a matching tracking identifier that was captured earlier in the vehicle. Lastly, in step 440, a customer care representative can use the customer care system 120 to analyze the customer's review and image to assess the customer's satisfaction.

In connection with method 400, it should be noted that customer privacy can also be ensured. For instance, in one example, only the customer tracking identifier will be linked with the menu item so that other customer information associated with the order is not associated with the customer review or the customer image.

Referring now to FIG. 5, an example method 500 for processing a refund request is illustrated. Example method 500 can take advantage of the tracking identifier stored in method 300 and the customer tracking identifier stored in method 400 in connection with processing a refund request. In step 505, the customer care system 120 receives a refund request from a customer. The refund request may be received in connection with a customer review or may be received separately. The refund request can be for a full refund or a partial refund. In step 510, in response to receiving the refund request, the customer care system 120 uses the menu item identifier associated with the refund request to retrieve the linked tracking identifier from the data warehousing system 120. As explained in method 300, the tracking identifier was obtained from the original image captured when the menu item was prepared onboard the mobile kitchen vehicle. The customer care system 120 can also retrieve from the data warehousing system 120 the original image obtained in method 300 as well as information gathered in method 400 including the customer review, the customer image, and the customer tracking identifier. Alternatively, if the customer tracking identifier has not yet been determined from the customer image, the customer care system 120 can use the image processing system 115 to obtain the customer tracking identifier from the customer image.

In step 515, the customer care system 515 can determine whether the tracking identifier and the customer tracking identifier match. If the two identifiers do not match, a customer care representative can investigate further as to whether the refund request is valid. The customer care representative can also compare the image and the customer image to determine whether the refund is valid. Comparing the image and the customer image can also be helpful in determining, for example, whether the customer received the wrong menu item. In step 520, the customer care representative can decide whether the customer is entitled to a partial or full refund. If the customer care representative determines that no refund is warranted, in step 540 the customer care system 120 can transmit a notification to the customer device 140 that a refund will not be provided and, optionally, include an explanation for the decision.

If the customer care representative determines a refund should be awarded, the customer care system 120 can send a refund message with the menu item identifier to the finance system 122 in step 525. In step 530, the finance system 122 uses the menu item identifier and the price associated with the menu item identifier to generate a refund to the customer. In step 535, the customer care system can send a notification of the refund to the customer device 140.

Referring now to FIG. 6, an example method for using a customer image of a menu item in a marketing process 600 is illustrated. Example method 600 can begin with the marketing subsystem 125 retrieving the customer review if the customer review has a threshold score. For example, if the customer review includes a score, such as a 4 out of 5, the marketing system 125 can retrieve the customer review if it includes a score of 4 or higher. As explained in connection with method 400, the customer review can have an associated customer image also stored in database 160. In one example embodiment, the marketing process 600 can include step 610 wherein the image processing system 115 analyzes the customer image and assigns an image score to the customer image. The image score can be useful in automating a decision about whether the customer image is of sufficient quality for use in one or more marketing approaches. For example, the image processing system 115 can determine the image score based on a lighting quality of the customer image (e.g. dark customer images can be avoided) or a color quality of the customer image (e.g. poor color images can be avoided). In alternate embodiments, step 610 can be optional and can be skipped in process 600.

In step 615, a marketing representative can select the customer image if the image score satisfies a threshold or if the marketing representative otherwise determines that the customer image is useful for marketing. In step 620, the marketing representative has selected the customer image for use in marketing, the marketing system can also use the menu item identifier or the customer tracking identifier associated with the customer image to retrieve an associated menu item description from the data warehousing system 130.

After completing step 620, the marketing system 125 can perform one or both of steps 625 and 630. In step 625, the marketing system 125 can publish the customer image and the menu item description in marketing media indicating the customer's satisfaction with the menu item. In step 630, the marketing system 125 can publish the customer image and menu item description in a photo contest. For example, as a promotion, the service provider can publish customer images and provide rewards to customers submitting high quality customer photos of the menu items. In the steps of method 600, the service provider operating system 100 can ensure customer privacy by first securing the customer's permission to use the customer image or by avoiding including any customer identifying information in the marketing publications.

With respect to the example methods described herein, it should be understood that in alternate embodiments, certain steps of the methods may be performed in a different order, may be performed in parallel, may be combined, or may be omitted. Moreover, in alternate embodiments additional steps may be added to the example methods described herein. Accordingly, the example methods provided herein should be viewed as illustrative and not limiting of the disclosure.

Similarly, for any apparatus shown and described herein, one or more of the components may be omitted, added, repeated, and/or substituted. Accordingly, embodiments shown in a particular figure should not be considered limited to the specific arrangements of components shown in such figure. Further, if a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure.

Terms such as “first”, “second”, “remote”, “distal”, “proximal”, and “within” are used merely to distinguish one element (or part of an element or state of an element) from another. Such terms are not meant to denote a preference or a particular orientation, and are not meant to limit the embodiments described herein. In the example embodiments described herein, numerous specific details are set forth in order to provide a more thorough understanding of the invention. However, it will be apparent to one of ordinary skill in the art that the embodiments may be practiced without these specific details. In other instances, well-known features have not been described in detail to avoid unnecessarily complicating the description.

Although example embodiments are described herein, it should be appreciated by those skilled in the art that various modifications are well within the scope of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A method for preparing, delivering, and tracking food, the method comprising:
transmitting, by a control computing system, an order comprising a menu item to a mobile kitchen vehicle, the mobile kitchen vehicle operable to prepare the menu item;
receiving, at the control computing system from the mobile kitchen vehicle, a completion notification indicating preparation of the menu item is complete, the completion notification having an associated image of the menu item in its completed state;
decoding, by an image processing system, a code within the associated image of the menu item to obtain a tracking identifier associated with the menu item; and
linking, by the control computing system, the tracking identifier with a menu item identifier, the menu item identifier associated with the menu item.

2. The method of claim 1, wherein the code within the associated image is attached to a container containing the menu item.

3. The method of claim 2, wherein the code within the associated image is one of a quick response code and a bar code.

4. The method of claim 1, wherein the mobile kitchen vehicle comprises:
a camera system that captures the associated image of the menu item; and
an onboard computing system, wherein the onboard computing system transmits the completion notification having the associated image of the menu item to the control computing system upon receiving an input that preparation of the menu item is complete.

5. The method of claim 1, further comprising:
receiving, at the control computing system, a customer review, the customer review having an associated customer image of the menu item;
decoding, by the image processing system, a customer code within the associated customer image of the menu item to obtain a customer tracking identifier associated with the menu item; and
linking, by the control computing system, the customer review, the associated customer image of the menu item, and the customer tracking identifier with the menu item identifier.

6. The method of claim 5, further comprising:
receiving, at the control computing system, a refund request for the menu item;
retrieving, at the control computing system, the tracking identifier, the customer review, the associated customer image of the menu item, and the customer tracking identifier;
determining, by the control computing system, that the tracking identifier and the customer tracking identifier match; and
issuing, by the control computing system, a refund.

7. The method of claim 5, further comprising:
retrieving, by the control computing system, the customer review based on a threshold score within the customer review;
determining, by the image processing system, a score for the associated customer image of the menu item, the score based on one or more of a color quality and lighting quality of the associated customer image of the menu item; and
publishing, by the control computer system, the menu item and the associated customer image.

8. A system for preparing, delivering, and tracking food, the system comprising:
a control computing system, wherein the control computing system is operable to receive an order comprising a menu item; and
a mobile kitchen vehicle operable to prepare the menu item,
wherein the control computing system comprises computer-readable instructions executable by a processor, the computer-readable instructions comprising:
transmitting, by the control computing system, the order comprising the menu item to the mobile kitchen vehicle;
receiving, at the control computing system from the mobile kitchen vehicle, a completion notification indicating preparation of the menu item is complete, the completion notification having an associated image of the menu item in its completed state;
decoding, by an image processing system, a code within the associated image of the menu item to obtain a tracking identifier associated with the menu item; and
linking, by the control computing system, the tracking identifier with a menu item identifier, the menu item identifier associated with the menu item.

9. The system of claim 8, wherein the code within the associated image is attached to a container containing the menu item.

10. The system of claim 9, wherein the code within the associated image is one of a quick response code and a bar code.

11. The system of claim 8, wherein the mobile kitchen vehicle comprises:
a camera system that captures the associated image of the menu item; and
an onboard computing system, wherein the onboard computing system transmits the completion notification having the associated image of the menu item to the control computing system upon receiving an input that preparation of the menu item is complete.

12. The system of claim 8, wherein the computer-executable instructions further comprise:
receiving, at the control computing system, a customer review, the customer review having an associated customer image of the menu item;
decoding, by the image processing system, a customer code within the associated customer image of the menu item to obtain a customer tracking identifier associated with the menu item; and
linking, by the control computing system, the customer review, the associated customer image of the menu item, and the customer tracking identifier with the menu item identifier.

13. The system of claim 12, wherein the computer-executable instructions further comprise:
receiving, at the control computing system, a refund request for the menu item;
retrieving, at the control computing system, the tracking identifier, the customer review, the associated customer image of the menu item, and the customer tracking identifier;
determining, by the control computing system, that the tracking identifier and the customer tracking identifier match; and
issuing, by the control computing system, a refund.

14. The system of claim 12, wherein the computer-executable instructions further comprise:
retrieving, by the control computing system, the customer review based on a threshold score within the customer review;
determining, by the image processing system, a score for the associated customer image of the menu item, the score based on one or more of a color quality and lighting quality of the associated customer image of the menu item; and
publishing, by the image processing system, the menu item and the associated customer image.

15. A non-transitory computer-readable medium comprising instructions executable by a processor, the instructions comprising:
transmitting, by a control computing system, an order comprising a menu item to a mobile kitchen vehicle, the mobile kitchen vehicle operable to prepare the menu item;
receiving, at the control computing system from the mobile kitchen vehicle, a completion notification indicating preparation of the menu item is complete, the completion notification having an associated image of the menu item in its completed state;
decoding, by an image processing system, a code within the associated image of the menu item to obtain a tracking identifier associated with the menu item; and
linking, by the control computing system, the tracking identifier with a menu item identifier, the menu item identifier associated with the menu item.

16. The non-transitory computer-readable medium of claim 15, wherein the code within the associated image is attached to a container containing the menu item.

17. The non-transitory computer-readable medium of claim 15, wherein the mobile kitchen vehicle comprises:
a camera system that captures the associated image of the menu item; and
an onboard computing system, wherein the onboard computing system transmits the completion notification having the associated image of the menu item to the control computing system upon receiving an input that preparation of the menu item is complete.

18. The non-transitory computer-readable medium of claim 15, the instructions further comprising:
receiving, at the control computing system, a customer review, the customer review having an associated customer image of the menu item;
decoding, by the image processing system, a customer code within the associated customer image of the menu item to obtain a customer tracking identifier associated with the menu item; and
linking, by the control computing system, the customer review, the associated customer image of the menu item, and the customer tracking identifier with the menu item identifier.

19. The non-transitory computer-readable medium of claim 15, the instructions further comprising:
receiving, at the control computing system, a refund request for the menu item;
retrieving, at the control computing system, the tracking identifier, the customer review, the associated customer image of the menu item, and the customer tracking identifier;
determining, by the control computing system, that the tracking identifier and the customer tracking identifier match; and
issuing, by the control computing system, a refund.

20. The non-transitory computer-readable medium of claim 15, the instructions further comprising:
retrieving, by the control computing system, the customer review based on a threshold score within the customer review;
determining, by the image processing system, a score for the associated customer image of the menu item, the score based on one or more of a color quality and lighting quality of the associated customer image of the menu item; and
publishing, by the image processing system, the menu item and the associated customer image.
